(19) United States
(12) Patent Application Publication
(10) Pub. No.: US 2026/0143191 A1
(43) Pub. Date: May 21, 2026

(54) CONTENT DELIVERY BASED ON PALM RECOGNITION

(71) Applicant: Tencent Technology (Shenzhen) Company Limited, Shenzhen (CN)

(72) Inventors: Shaoming WANG, Shenzhen (CN); Jinkun HOU, Shenzhen (CN); Runzeng GUO, Shenzhen (CN); Nanjin CHEN, Shenzhen (CN)

(73) Assignee: Tencent Technology (Shenzhen) Company Limited, Shenzhen (CN)

(21) Appl. No.: 19/445,213

(22) Filed: Jan. 9, 2026

Related U.S. Application Data
(63) Continuation of application No. PCT/CN2024/107076, filed on Jul. 23, 2024.

(30) Foreign Application Priority Data
Sep. 21, 2023 (CN) 202311237249.X

(51) Int. Cl. H04N 21/4415; G06V 10/26; G06V 10/30; G06V 10/40; G06V 20/40; G06V 40/12; G06V 40/20; H04N 21/2187; H04N 21/45; H04N 21/466

(52) U.S. Cl. CPC H04N 21/4415; G06V 10/273; G06V 10/30; G06V 10/40; G06V 20/40; G06V 40/1347; G06V 40/1365; G06V 40/28; H04N 21/2187; H04N 21/4532; H04N 21/4668

(57) ABSTRACT

In an information pushing method, a palm image of a user acquired by a frontend device during a service process is obtained. Palmprint recognition is performed on the palm image to obtain identity information of the user. Push information that matches the identity information of the user is searched. Based on the identity information of the user, an identity signature for use in the service process is generated. The identity signature is fed back to the frontend device. On the frontend device, the push information is output for display during the service process.

### RELATED APPLICATIONS

The present application is a continuation of International Application No. PCT/CN2024/107076, filed on Jul. 23, 2024, which claims priority to Chinese Patent Application No. 202311237249.X, entitled “INFORMATION PUSHING METHOD AND APPARATUS, COMPUTER DEVICE, AND STORAGE MEDIUM” and filed on Sep. 21, 2023. The entire disclosures of the prior applications are hereby incorporated by reference.

### FIELD OF THE TECHNOLOGY

This application relates to the field of computer technologies, including an information pushing method.

### BACKGROUND OF THE DISCLOSURE

As computer technologies and biometric recognition technologies develop, a palmprint recognition technology emerges, which is a novel biometric feature recognition technology put forward in the late 19^{th} century. A palmprint is a palm image that covers a region from finger roots to a wrist. Many features, such as principal lines, wrinkles, fine textures, ridge tips, and branch points, may be configured for identity recognition. Palmprint recognition is a non-intrusive recognition method, offering high user acceptance and low requirements on acquisition devices. Currently, dedicated acquisition devices can be used to acquire palmprint information of users, to perform palmprint recognition.

However, currently, screens of palmprint acquisition devices display only essential indication information, for example, a position for a user to place a palm. Consequently, screen utilization is low, resulting in a resource waste.

### SUMMARY

Aspects of this disclosure provide an information pushing method, an information pushing apparatus, and a non-transitory computer-readable storage medium. Examples of technical solutions of this disclosure may be implemented as follows:
An aspect of this disclosure provides an information pushing method. In the method, a palm image of a user acquired by a frontend device during a service process is obtained. Palmprint recognition is performed on the palm image to obtain identity information of the user. Push information that matches the identity information of the user is searched. Based on the identity information of the user, an identity signature for use in the service process is generated. The identity signature is fed back to the frontend device. On the frontend device, the push information is output for display during the service process.
An aspect of this disclosure provides an information processing apparatus. The apparatus includes processing circuitry configured to obtain a palm image of a user acquired by a frontend device during a service process. The processing circuitry is configured to perform palmprint recognition on the palm image to obtain identity information of the user. The processing circuitry is configured to search for push information that matches the identity information of the user. The processing circuitry is configured to generate, based on the identity information of the user, an identity signature for use in the service process. The processing circuitry is configured to feed back the identity signature to the frontend device. The processing circuitry is configured to output for display, on the frontend device, the push information during the service process.
According to a first aspect, this disclosure provides an information pushing method, which is performed by a computer device and includes: obtaining a palm image of a user acquired by a frontend device in a service processing process; performing palmprint recognition based on the palm image, to obtain identity information of the user; searching for push information matching the identity information of the user; and generating, based on the identity information of the user, an identity signature to be used in the service processing process, feeding back the identity signature to the frontend device, and feeding back the push information to the frontend device, to instruct the frontend device to perform service processing by using the identity signature and play the push information in the service processing process.
According to a second aspect, this disclosure further provides an information pushing apparatus, including: a data obtaining module, configured to obtain a palm image of a user acquired by a frontend device in a service processing process; a palmprint recognition module, configured to perform palmprint recognition based on the palm image, to obtain identity information of the user; a push information searching module, configured to search for push information matching the identity information of the user; and an information pushing module, configured to: generate, based on the identity information of the user, an identity signature to be used in the service processing process, feed back the identity signature to the frontend device, and feed back the push information to the frontend device, to instruct the frontend device to perform service processing by using the identity signature and play the push information in the service processing process.
According to a third aspect, this disclosure further provides a computer device, including a memory and a processor. The memory has a computer program stored therein. The processor, when executing the computer program, implements the following operations: obtaining a palm image of a user acquired by a frontend device in a service processing process; performing palmprint recognition based on the palm image, to obtain identity information of the user; searching for push information matching the identity information of the user; and generating, based on the identity information of the user, an identity signature to be used in the service processing process, feeding back the identity signature to the frontend device, and feeding back the push information to the frontend device, to instruct the frontend device to perform service processing by using the identity signature and play the push information in the service processing process.
An aspect of this disclosure provides a non-transitory computer-readable storage medium storing instructions which, when executed by a processor, cause the processor to implement the foregoing information pushing methods.
According to another aspect, this disclosure further provides a computer program product, including a computer program. The computer program, when executed by a processor, implements the following operations: obtaining a palm image of a user acquired by a frontend device in a service processing process; performing palmprint recognition based on the palm image, to obtain identity information of the user; searching for push information matching the identity information of the user; and generating, based on the identity information of the user, an identity signature to be used in the service processing process, feeding back the identity signature to the frontend device, and feeding back the push information to the frontend device, to instruct the frontend device to perform service processing by using the identity signature and play the push information in the service processing process.

Details of one or more aspects of this disclosure are provided in the following drawings and descriptions. Other features, objectives, and advantages of this disclosure become apparent from the specification, the drawings, and the claims.

### BRIEF DESCRIPTION OF THE DRAWINGS

FIG. 1 is a diagram of an application environment of an information pushing method according to an aspect.

FIG. 2 is a schematic flowchart of an information pushing method according to an aspect.

FIG. 3 is a schematic diagram of a palm authentication process according to an aspect.

FIG. 4 is a structural block diagram of a system backend service of an information pushing system according to an aspect.

FIG. 5 is a structural block diagram of a user terminal of the information pushing system according to an aspect.

FIG. 6 is a structural block diagram of a frontend device of the information pushing system according to an aspect.

FIG. 7 is a schematic diagram of a processing process of the information pushing system according to an aspect.

FIG. 8 is a timing diagram of a processing process of an information pushing method according to an aspect.

FIG. 9 is a schematic flowchart of an information pushing method according to another aspect.

FIG. 10 is a structural block diagram of an information pushing apparatus according to an aspect.

FIG. 11 is a diagram of an internal structure of a computer device according to an aspect.

### DETAILED DESCRIPTION

Technical solutions of aspects of this disclosure are described below in combination with drawings of the aspects of this disclosure. The described aspects are merely some aspects rather than all aspects of this disclosure. Other aspects shall fall within the scope of this disclosure. Further, the descriptions of the terms are provided as examples only and are not intended to limit the scope of the disclosure.

User information (including and not limited to user equipment information and user personal information) and data (including and not limited to data for analysis, stored data, and displayed data) involved in this disclosure both are information and data authorized by a user or fully authorized by all parties, and collection, use, and processing of related data need to comply with relevant regulations.

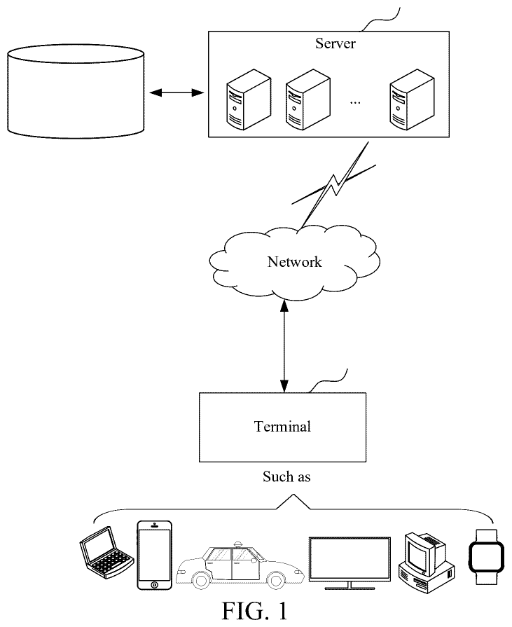

An information pushing method provided in the aspects of this disclosure may be applied to an application environment shown in FIG. 1. A frontend device 102 communicates with a server 104 through a network. A data storage system may store data to be processed by the server 104. The data storage system may be integrated onto the server 104, or may be placed on a cloud or another network server. In a service processing process performed by a user, if the service processing process involves identity authentication, the user may perform palm authentication by using a palm authentication apparatus on the frontend device 102, to perform identity authentication. First, the user performs palm authentication by using the palm authentication apparatus on the frontend device 102, so that the frontend device 102 may obtain a palm image of the user, and then submits the palm image of the user to the server 104. Therefore, the server 104 may obtain the palm image of the user acquired by the frontend device 102 in the service processing process; perform palmprint recognition based on the palm image, to obtain identity information of the user; search for push information matching the identity information of the user; and generate, based on the identity information of the user, an identity signature to be used in the service processing process, and feed back the identity signature and the push information to the frontend device 102, so as to perform service processing on the frontend device 102 by using signature information provided in the identity signature, and play the push information in the service processing process by using a display apparatus provided by the frontend device 102. The frontend device 102 may be, and is not limited to, various personal computers, notebook computers, smart phones, tablet computers, Internet of Things devices, and portable wearable devices. The Internet of Things devices may be smart speakers, smart televisions, smart air conditioners, smart on-board devices, or the like. The portable wearable devices may be smart watches, smart bracelets, head-mounted devices, or the like. The frontend device 102 includes a palm authentication apparatus and a display apparatus. A user may input a palm image to the palm authentication apparatus to perform palm authentication. The display apparatus is configured to play push information found by searching. The server 104 may be implemented by using an independent server or a server cluster composed of a plurality of servers.

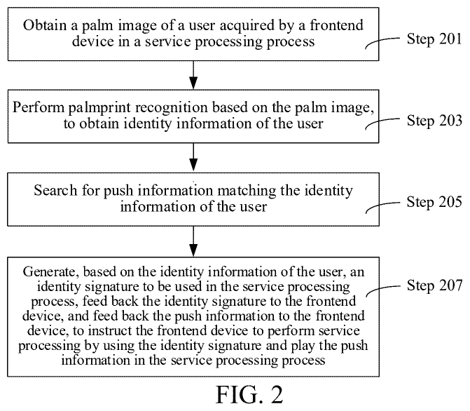

In an aspect, as shown in FIG. 2, an information pushing method is provided. A description is provided by using an example that the method is applied to the server 104 in FIG. 1. The method includes operation 201 to operation 207 described below.

Operation 201: Obtain a palm image of a user acquired by a frontend device in a service processing process. For example, a palm image of a user acquired by a frontend device during a service process is obtained.

The frontend device 102 is a device configured to acquire palm information of a user. The frontend device 102 includes a palm authentication apparatus and a display apparatus. A user may input a palm image to the palm authentication apparatus to perform palm authentication. In addition, the frontend device may further perform service processing. The service processing process may be a processing process in which signature authentication needs to be performed based on identity information of the user. For example, in an aspect, the service processing process is a login process. In this case, the user may perform palm authentication on the frontend device 102, to provide an identity signature corresponding to the identity information to log in to a corresponding service.

In another aspect, the service processing process is a resource transfer settlement process. In this case, the user may perform palm authentication on the frontend device 102 to provide a corresponding identity signature, and then perform resource transfer settlement confirmation based on the identity signature. The palm image of the user is a palm image that is acquired through the frontend device 102 and that may be configured for palmprint recognition, and the palm image includes palm information of the user. For example, the frontend device 102 may acquire a plurality of images including the palm of the user, and then select a palm image that may be configured for palmprint recognition.

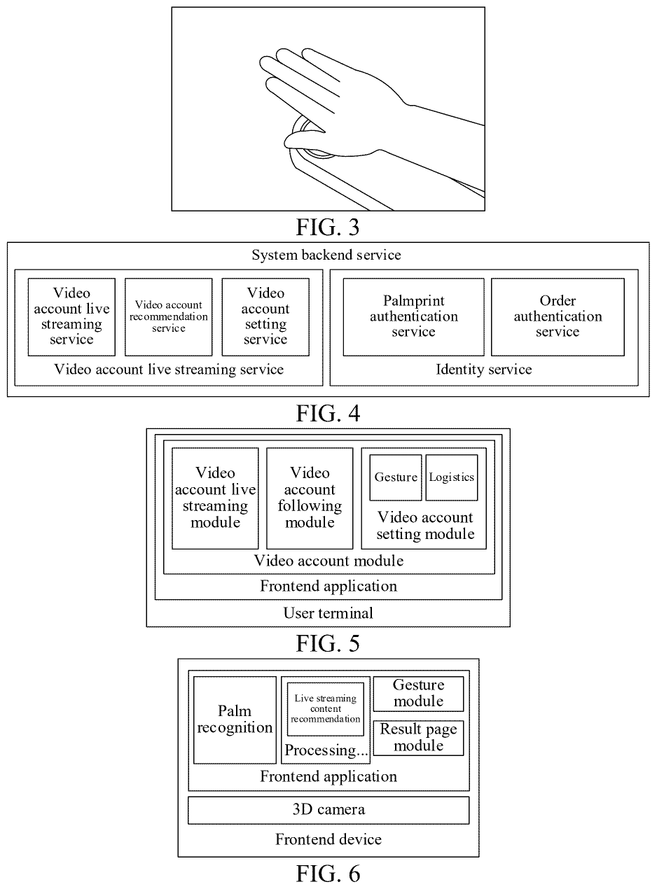

For example, the information pushing method of this disclosure is applied to a service process in which palm authentication needs to be performed. Because some tasks requiring identity information, for example, resource transfer tasks in which user identity information needs to be confirmed and cancellation and order checking tasks, which involve a long process, information may be pushed to a user, to enhance information pushing effectiveness. Therefore, as shown in FIG. 3, when a user performs service processing through the frontend device 102 and performs identity authentication through the palm authentication apparatus of the frontend device 102, the palmprint authentication may be implemented through the server 104 of this disclosure, and corresponding information is customized and pushed to the user in combination with identity information of the user, thereby ensuring information pushing effectiveness. Therefore, in the solution of this disclosure, the palm image of the user needs to be first acquired through the frontend device 102, which is used as basic data of the palmprint authentication process and the information pushing process. The server 104 directly obtains the palm image of the user acquired by the frontend device in the service processing process, and starts corresponding authentication.

Operation 203: Perform palmprint recognition based on the palm image, to obtain identity information of the user. For example, palmprint recognition is performed on the palm image to obtain identity information of the user.

Palmprint recognition is a biometric feature recognition technology that performs identity recognition based on palmprints. The palmprints are various lines on a palm surface between a wrist and fingers. Palmprint morphology is genetically controlled. Even when epidermal damage occurs, regenerated palmprint lines retain the original structure. Each individual's palmprint lines are unique. Even twins exhibit closely resembling but not identical palmprints. Therefore, palmprints enable non-intrusive recognition of identity information of a user while ensuring accuracy of the recognition. In an example aspect, a palmprint feature may be extracted from a palm image to perform palmprint recognition. Information included in a palmprint is far richer than information included in a fingerprint. A line feature, a point feature, a texture feature, and a geometrical feature of the palmprint may be extracted, with which an identity feature of a user may be determined.

For example, after the palm image of the user is obtained from the frontend device 102, palmprint recognition may be performed based on the palm image. For example, feature extraction may be performed on the current palm image, various extracted palm features are compared with features in a database to find feature data with a highest score, and related palm data is compared with palms in a backend database, to determine a palm feature in the database corresponding to the palm image, and then the database is searched for identity information of a user corresponding to the palm feature, to determine the identity information of the user. For a process of the palmprint recognition, a hand region in the image may be first recognized, then various feature information such as a line feature, a point feature, a texture feature, and a geometrical feature of a palmprint in the hand image is separately extracted through a pre-established machine learning model, and is compared with palmprint feature in the database, and then the identity information of the user is obtained based on a comparison result.

Operation 205: Search for push information matching the identity information of the user. For example, push information that matches the identity information of the user is searched.

The push information is media content in which the user is interested that is determined based on the identity information, for example, program announcement push information, live streaming push information, commodity push information, or service push information. A presentation form of the push information may be animated content, videos, or the like.

For example, to implement more effective information pushing, various media content in which the user is interested may be pre-determined based on a browsing record, a watching record, or the like of the user. In an example aspect, interests and preferences of the user may be predicted through technologies such as collaborative filtering and content filtering, to determine media content in which the user is interested for pushing. In an example aspect, the push information may be live streaming content. In this case, a live streaming room that is followed by the user and that is performing live streaming may be searched for and pushed, and the live streaming content is presented to the display apparatus of the frontend device.

Operation 207: Generate, based on the identity information of the user, an identity signature to be used in the service processing process, feed back the identity signature to the frontend device, and feed back the push information to the frontend device, to instruct the frontend device to perform service processing by using the identity signature and play the push information in the service processing process. For example, based on the identity information of the user, an identity signature for use in the service process is generated. The identity signature is fed back to the frontend device. On the frontend device, the push information is output for display during the service process.

The identity signature is data that is generated based on identity information of an object and that is configured for performing identity authentication in a service process, which may include signature information. For example, when the identity information of the user is determined, a QR code corresponding to the identity information may be generated, and the QR code is used as the identity signature. The identity signature may be used as a certificate for providing signature information in the service processing process, to promote the information push processing process.

For example, after the push information matching the identity information of the user is found by searching, identity information to be used in the identity authentication process and identity information to be used in the information pushing process are obtained. In this case, for the identity signature, the identity signature to be used in the service processing process may be first generated based on the identity information of the user. The identity signature may be generated based on signature information matching a service type of service processing. However, identity signature matching a common task may be automatically generated or may be preset by a user. Then, the identity signature and the push information are directly fed back to the frontend device 102. The frontend device 102 may separately perform corresponding service processing after receiving the two types of information. For the identity signature, the identity signature may be loaded in an original service processing process for authentication, and service processing after the authentication is performed. For the push information, the push information may be played on the display apparatus of the frontend device 102 in the service processing process in the background of the frontend device 102, and the user providing the palm image may view the push information on the frontend device 102. In an example aspect, the push information may be live streaming information regarding product recommendation. Therefore, the user may perform processing such as adding to favorites or ordering on a recommended product through the frontend device 102 while watching live streaming, thereby improving an information pushing effect.

According to the content pushing method, the palm image of the user acquired by the frontend device in the service processing process is first obtained, to obtain basic data for palmprint authentication, then palmprint recognition may be performed based on the palm image, to obtain the identity information of the user to be used in the service processing process through the palmprint recognition, the push information matching the identity information of the user is searched for, to obtain push information more closely associated with the user, then the identity signature to be used in the service processing process is generated based on the identity information of the user, the identity signature and the push information are fed back to the frontend device, so as to perform service processing by using the identity signature, and the push information is played in the service processing process. In other words, through feedback of the identity signature and the push information, the push information associated with the user can be pushed on a palmprint recognition device of the frontend in the service processing process performed by using the signature information provided in the identity signature, so that the push information can be played during the service processing performed based on the identity signature, thereby effectively utilizing a screen, improving resource utilization of the screen, and avoiding a resource waste. In addition, because the push information matching the identity information of the user is pushed, a resource waste as a result of randomly pushing useless information to the user can be avoided.

In an aspect, the information pushing method further includes: searching for preset gesture information corresponding to the identity information; performing, when acquired gesture information fed back by the frontend device based on the push information is received, gesture authentication on the acquired gesture information by using the preset gesture information; and generating order information corresponding to the push information when the gesture authentication succeeds.

The preset gesture information is preset by the user, and may be configured for processing such as information authentication or order generation. The acquired gesture information is a gesture made by a user acquired by an image acquisition device such as the palm authentication apparatus of the frontend device. Gesture authentication means comparing preset gesture information pre-stored by the user with acquired gesture information made in real time to determine whether to trigger an action of generating an order, so as to generate order information corresponding to the push information.

For example, the push information is information configured for pushing commodity content, service content, or business content to the user. The push information includes the pushed commodity content, service content, or business content. The user may determine whether to perform ordering on the commodity content, the service content, or the business content included in the push information, to obtain a corresponding commodity, service, or the like. An order triggering manner for the push information may be triggering through an action performed by the user on the frontend device. When watching the played push information and determining to trigger an order of the push information, the user may perform a corresponding action on the image acquisition apparatus (for example, the palm authentication apparatus configured to acquire the palm image) of the frontend device. Then, the image acquisition device acquires the images as acquired gesture information and transmits the acquired gesture information to a backend for gesture authentication. The backend searches, based on the information pre-stored by the user, the database for the preset gesture information corresponding to the identity information, and then performs gesture authentication on the acquired gesture information by using the preset gesture information. For example, an image feature of the reserved preset gesture information may be compared with an image feature of the acquired gesture information, to implement the gesture authentication on the acquired gesture information. When the gesture authentication succeeds, order information corresponding to the push information may be directly generated, so as to provide a corresponding commodity or service to the user. In this aspect, after the information is pushed, the preset gesture information provided by the user is received, to generate the order information corresponding to the push information, which can effectively improve generation efficiency of the order information in an order placing process performed by the user.

In an aspect, the generating order information corresponding to the push information when the gesture authentication succeeds includes: searching for service information corresponding to the push information when the gesture authentication succeeds; searching, based on the identity information, for receiver address information and receiver information that are preconfigured by the user; and filling in an order table corresponding to the service information based on the receiver address information and the receiver information, to generate the order information corresponding to the push information.

The service information corresponding to the push information is service content, such as a commodity or a service, presented through the push information. The receiver address information and the receiver information that are preconfigured by the user are logistics information pre-configured by the user at the background. The logistics information that may be pre-configured by the user at the background mainly includes basic information such as a name, an address, a phone number, a postal code, and an express company of a receiver.

For example, for an order generation process, when the gesture authentication succeeds, service information corresponding to the push information may be searched for first, i.e., a commodity or service content carried in the push information is determined first. In an aspect, the solution of this disclosure is applicable to commodity information pushing. In this case, during information pushing, a commodity serial number corresponding to the information push information may be directly searched for, and then commodity information is obtained through the serial number. In addition, to generate order information, delivery address information of the user needs to be further determined. In this case, because the user pre-configures the logistics information such as the receiver address information and the receiver information in the background, the receiver address information and the receiver information that are pre-configured by the user may be directly found by searching based on the identity information of the user. Subsequently, necessary order information such as the service information and the logistics information is filled in the order table, so that the order information corresponding to the push information can be directly generated in the background. In an aspect, after the order information is generated, the order information may be further pushed to a backend account of the user based on the identity of the object, so that the user performs confirmation processing on the generated order information, thereby ensuring effectiveness of the generated order information.

In an aspect, the performing gesture authentication on the acquired gesture information by using the acquired gesture information includes: obtaining a gesture image in the acquired gesture information; extracting a hand region image from the gesture image; extracting an image feature of the hand region image; comparing the image feature of the hand region image with an image feature of the preset gesture information, to obtain a gesture feature comparison result; and determining a result of the gesture authentication on the acquired gesture information based on the gesture feature comparison result.

The gesture image is a complete image including a hand action of the user. The hand region image is an image of a complete hand region obtained after background content in the gesture image is removed. The image feature is feature information corresponding to the hand action extracted through a pre-trained machine learning model.

For example, in the solution of this disclosure, gesture authentication may be performed by using a computer vision technology. First, the frontend device needs to acquire an image including a gesture as acquired gesture information. The gesture image may be acquired by one or more cameras of the frontend device. After acquiring images, the frontend device further processes the acquired images, for example, deletes partial images not including a hand from the acquired images, and recognizes angles, positions, and the like of gestures in the other images, to select an optimal image as the gesture image. Then, the backend server may perform corresponding gesture authentication based on the gesture image submitted by the frontend device. First, the hand region image in the gesture image may be extracted through a series of processing processes such as preprocessing and hand region positioning. Then, the image feature of the hand region image may be extracted through the pre-trained machine learning model. The extracted image feature of the hand region mainly includes a visual feature and a semantic feature. The visual feature includes a color, a texture, and an outline, and the semantic feature represents comprehension of image content. After the image feature of the hand region image is extracted, the image feature of the hand region image and the image feature of the preset gesture information may be directly compared. For example, a similarity between the two image features may be calculated as a gesture feature comparison result. For a processing process of determining a result of the gesture authentication on the acquired gesture information based on the gesture feature comparison result, it may be determined whether the similarity between the two features is greater than a preset similarity threshold. When the gesture feature comparison result indicates that the similarity between the two features is greater than or equal to the preset similarity threshold, it indicates that the gesture provided by the frontend device is similar to the gesture pre-stored by the user in the system. In this case, it may be determined that the gesture authentication on the acquired gesture information provided by the frontend device succeeds. If the gesture feature comparison result indicates that the similarity between the two features is less than the preset similarity threshold, it indicates that the gesture provided by the frontend device has weak association with the gesture pre-stored by the user in the system. In this case, information indicating an authentication failure and prompting the user to re-perform gesture authentication may be fed back. In this aspect, the processing such as hand region image extraction, image feature extraction, and feature comparison is performed, and the gesture authentication is completed in a machine learning manner, so that accuracy and efficiency of the gesture authentication can be effectively ensured.

In an aspect, the extracting a hand region image from the gesture image includes: performing noise removal and information enhancement on the gesture image, to obtain a preprocessed image; determining a hand region in the preprocessed image through gesture-based positioning; determining a segmentation contour corresponding to the hand region through color-based positioning; and performing image segmentation on the preprocessed image based on the segmentation contour, to obtain the hand region image.

For example, for a process of extracting a hand region image from the gesture image, for example, noise removal and information enhancement may be first performed on the gesture image, to obtain a preprocessed image; a hand region in the preprocessed image is determined through gesture-based positioning; a segmentation contour corresponding to the hand region is determined through color-based positioning; and image segmentation is performed on the preprocessed image based on the segmentation contour, to obtain the hand region image. Through the noise removal and the information enhancement, information density of the gesture image can be improved, thereby ensuring accuracy of the gesture authentication. However, for determining the hand region in the preprocessed image through gesture-based positioning, the gesture-based positioning process primarily serves to position the hand region from a complex background of the gesture image, thereby implementing separation between the gesture and the background. After the gesture is positioned, the current gesture is segmented from the background region through an algorithm. The segmentation algorithm may employ color-based segmentation. For example, the segmentation contour corresponding to the hand region is determined through color-based positioning based on a color difference between the hand and the background, and then image segmentation is performed on the preprocessed image based on the segmentation contour, to obtain the hand region image. A color model is pre-established, and then image segmentation is performed in combination with a skin color, a motion, contour information from the gesture authentication, which can significantly improve segmentation precision, and obtain a more effective hand region image. In this aspect, preprocessing, gesture-based positioning, and color-based segmentation are performed on the gesture image, so that accuracy of recognizing the hand region in the image can be effectively improved, thereby ensuring the accuracy of gesture recognition.

In an aspect, operation 201 includes: acquiring palm streaming media data of the user through the frontend device in the service processing process; recognizing palm information and image quality information of each frame of image in the palm streaming media data; and performing image screening on the palm streaming media data based on the palm information and the image quality information, to obtain the palm image of the user acquired by the frontend device.

The palm streaming media image is video content of palm content of the user acquired by the palm authentication apparatus of the frontend device, and the palm streaming media image includes a plurality of frames of images. The palm information includes information such as a palm size and a palm angle, and the image quality information includes information such as image contrast, image brightness, and definition.

For example, for a process of acquiring the palm image, to improve the palmprint recognition accuracy, acquired image information may be processed on the frontend device, to obtain a palm image including more palmprint information. Therefore, a camera may be first invoked on the frontend device to acquire current palm streaming media data of the user. After obtaining the palm streaming media data, the frontend device may further perform preference processing on the plurality of images in the palm streaming media data. A basis for the preference processing may be the palm information such as a palm size and a palm angle and the image quality information such as image contrast, image brightness, and definition. After obtaining the data, the palm streaming media data is screened through comprehensive evaluation in combination with corresponding coefficient indexes, to determine an optimal palm image, thereby obtaining a palm image that may be configured for palmprint recognition. Subsequently, the palm image may be transmitted to the backend for palmprint recognition. In this aspect, the screening on the palm image is completed through the palm information and the image quality information, so that reliability of the palm image can be effectively improved, thereby improving the accuracy of palmprint recognition and ensuring an information pushing effect.

In an aspect, operation 205 includes: searching for a browsing history and a playback history that correspond to the identity information; and performing preference prediction based on the browsing history and the playback history, to obtain the push information matching the identity information of the user.

The browsing history is record information generated when the user browses a commodity page or a service page through a frontend page of the pushing system, and the playback history is record information generated when the user historically watches various live streaming or recommended video content through the frontend page of the pushing system. Preference prediction means predicting an interest and a preference of the user through the information such as a browsing history and a playback history of the user, and then pushing push information corresponding to the interest and the preference of the user to the user.

For example, a system architecture of the information pushing method in this disclosure may further include a user terminal in addition to the frontend device and the backend server, and the backend server provides various services to the user by using a frontend application on the user terminal. The user generates various browsing histories and playback histories during use of the frontend application. The backend server may search the background for the browsing history and the playback history that correspond to the identity information under user consent. Then, the backend performs preference prediction processing through the pre-trained machine learning model, to obtain the interest and the preference of the user. Then association searching is performed on all to-be-pushed content based on the interest and the preference, to precisely identify push information in which the user is interested, thereby implementing precise information pushing and ensuring accuracy of information pushing. In this aspect, the browsing history and the playback history of the user are analyzed to perform preference prediction, to determine the push information corresponding to the user, thereby effectively ensuring effectiveness of the information pushing process.

In an aspect, the performing preference prediction based on the browsing history and the playback history, to obtain the push information matching the identity information of the user includes: determining a similarity between the user and each user set based on the browsing history and the playback history; determining a similar user set of the user based on the similarity; searching for preference content of the similar user set; and obtaining, based on the preference content, the push information matching the identity information of the user.

A user set is a collection where users are pre-categorized into distinct groups through methods such as clustering based on browsing histories and playback histories of the users. Users in each user set have same or similar interests and preferences. After a user set is obtained, summarization and analysis may be performed on browsing histories and playback histories of users in the obtained user set, to obtain preference content of the user set. The similar user set is a user set having a highest similarity with the user.

For example, in the solution of this disclosure, preference prediction may be performed on the user through determining of a similar user set of the user. First, a similarity between the user and each user set needs to be determined based on the browsing history and the playback history, to determine a user set most similar to the current user. In an aspect, a process of calculating the similarity may be performed based on the browsing history and the playback history of the user. A preference feature vector of the user is established, and then a similarity distance between a preference feature of the user and a user set feature corresponding to each user set is determined, to determine the similarity between the user and each user set. For the user set feature corresponding to each user set, for example, a feature of each user in the user set may be determined first, and then the user set feature of the user set is obtained through averaging. The similarity distance may be a Euclidean distance or a cosine distance. After the Euclidean distance or the cosine distance is obtained, the similarity between the user and each user set may be determined. After the similar user set is obtained, common preference content of the similar user set may be found by searching based on setting of the user set, and then the push information matching the identity information of the user is obtained based on the preference content. For example, information, in the preference content, that has been browsed by the user may be filtered out based on the browsing history and the playback history of the user, and then the preference content after the filtering is pushed. In this aspect, the similar user set of the user is searched for, and then the information is pushed based on the common preference content of the similar user set, so that effectiveness of searching for the push information can be effectively ensured, thereby improving an information pushing effect.

In an aspect, the push information includes live streaming push information. The searching for push information matching the identity information of the user includes: determining, based on the identity information, live streaming content followed by the user; searching for live streaming rooms in the live streaming content followed by the user that are in a live state; and selecting a target live streaming room based on live streaming information of the live streaming rooms, and using the live streaming information of the target live streaming room as the push information matching the identity information of the user.

The live streaming content followed by the user is a live streamer or a live streaming column followed by the user. The live streaming information of the live streaming room may include popularity of the live streaming room, prevalence of an anchor, a live streaming type, a following duration of the user, and the like. A final to-be-pushed target live streaming room may be selected from the live streaming rooms followed by the user through the live streaming information of the live streaming rooms.

For example, to improve the information pushing effect, live streaming content that is performing live streaming may be pushed to the frontend device as push information and played. Therefore, during information pushing, the live streaming content followed by the user may be first determined based on the identity information. Then, states of the live streaming content are searched for, and the live streaming rooms in the live streaming content followed by the user that are currently in a live state are determined. Then, a target live streaming room is selected from these live streaming rooms based on live streaming information such as popularity of the live streaming rooms, prevalence of anchors, live streaming types, and following durations of the user, and then the live streaming information of the target live streaming room is used as the push information matching the identity information of the user. In an example aspect, a live streaming room that is performing live streaming regarding recommendation (for example, a live streaming room for commodity recommendation) may be selected based on a live streaming type, and then live streaming information of the live streaming room is used as the push information matching the identity information of the user. In this case, for a process of generating the push information, the video stream data and the service recommendation data of the target live streaming room may be first obtained after the target live streaming room is selected, then the video push information is generated based on the video stream data and the service recommendation data, and the video push information is fed back to the frontend device through the content delivery network. In this case, the live streaming information and the recommendation information may be simultaneously displayed on the display apparatus of the frontend device, and the user may determine whether to place an order based on the live streaming content and the recommendation information. In an example aspect, the information pushing method of this disclosure is implemented through an information pushing system. The information pushing system includes a system backend service shown in FIG. 4, a user terminal shown in FIG. 5, and a frontend device shown in FIG. 6. The system backend service is connected to the user terminal and the frontend device. The system backend service may include a video account live streaming service and an identity authentication service. The video account live streaming service may be configured for providing a live streaming service, a recommendation service, a setting service, or the like for various video accounts. The identity authentication service includes a palmprint authentication service and a gesture authentication service, and provides services for processes of palmprint recognition and gesture authentication. On the user terminal, a service may be provided for the user through a frontend application. A video account module of the frontend application includes: a video account live streaming module, configured to provide live streaming video accounts for the user; a video account following module, through which the user may follow a video account in which the user is interested; and a video account setting module, where the user may input, by using a gesture module in the video account setting module, preset gesture information configured for gesture authentication, and may further preset logistics information configured for order generation. The frontend device includes a three-dimensional (3D) camera module and a frontend application module. The 3D camera module is configured to perform authentication by using information such as a palm and a gesture of the user. A palm recognition module is configured to extract a palm image from a video recorded by the 3D camera module for palmprint recognition by a backend. A processing module is configured to perform service processing. The push information is displayed on a page of the processing module. The gesture module is configured to perform gesture authentication-related processing on the frontend. Finally, a result page module may display a service processing result or an order generation result of order placing performed by the user based on the push information. In this aspect, the live streaming content followed by the user is determined, to perform live streaming content recommendation, thereby effectively improving the information pushing effect through live streaming-based information pushing.

In an aspect, the selecting a target live streaming room based on live streaming information of the live streaming rooms, and using the live streaming information of the target live streaming room as the push information matching the identity information of the user includes: selecting the target live streaming room based on the live streaming information of the live streaming rooms, and obtaining the live streaming information of the target live streaming room; searching for to-be-pushed services corresponding to the frontend device; determining a target service in the to-be-pushed services that is associated with the live streaming information; and using the target service and the live streaming information as the push information matching the identity information of the user.

For example, in addition to pushing a remote service order through live streaming information, the solution of this disclosure may further push various service information of a location of the frontend device through a remote live streaming service. In this case, the target live streaming room may be first selected based on the live streaming information of the live streaming rooms, and the live streaming information of the target live streaming room is obtained, so as to obtain partial information streams that may be pushed, then the to-be-pushed services corresponding to the frontend device are searched for, and the target service in the to-be-pushed services that is associated with the live streaming information is determined. The to-be-pushed services are services that may be provided to the user on the frontend device side. For example, in a scenario in which a user is shopping at a shop, the to-be-pushed services may be types of commodities that can be provided at the shop. The target service in the to-be-pushed services that is associated with the live streaming information is recommendation content in the shop the same as or similar to the live streaming information. For example, for goods-sell live streaming, a same or similar commodity in the goods-sell live streaming may be used as the target service associated with the live streaming information. Then the target service and the live streaming information are used as the push information matching the identity information of the user. The user may directly determine, based the recommendation content of the push information, whether to place an order for service content included in the push information. An order placing process may also be implemented through the provided preset gesture information. In this case, settlement may be directly completed on the frontend device, without a need to generate an order for delivery, thereby significantly accelerating the service process and improving processing efficiency of the service pushing process.

In an aspect, the method further includes: generating push continuation information corresponding to the push information when a service completion message fed back by the frontend device is received, and pushing the continuation information to the user terminal of the user.

For example, the user may need to leave the frontend device after the service processing performed on the frontend device is completed, but the playback of the pushed live streaming information may not end and the user wants to continue to watch the pushed live streaming information then. Therefore, to ensure continuity of live streaming pushing, when the service completion message fed back by the frontend device is received, the push continuation information corresponding to the push information may be generated based on the pushed live streaming signal. The push continuation information may be pushed to the user terminal of the user. In this case, the user may continue to watch the live streaming on the user terminal. In this aspect, the live streaming continuation information is pushed after the service processing is completed, so that the live streaming content is further played on the user terminal of the user, thereby effectively ensuring continuity of live streaming pushing and improving the information pushing effect.

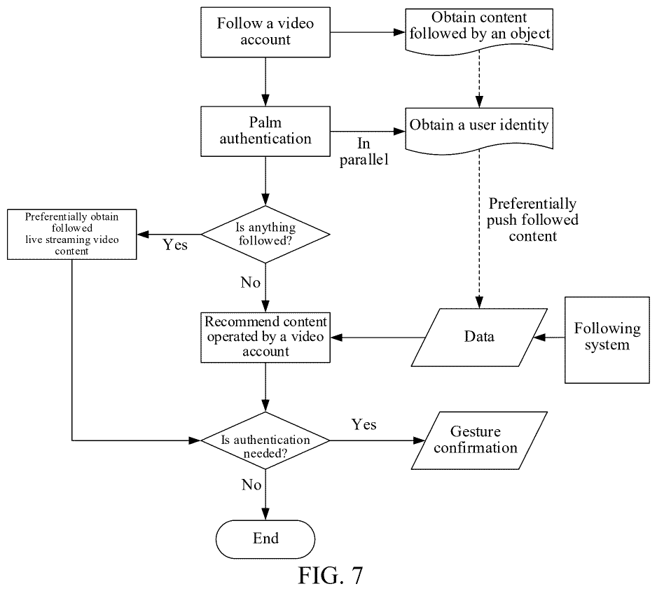

This disclosure further provides an application scenario. The foregoing information pushing method is applied to the application scenario. For example, the application of the information pushing method in the application scenario is as follows:
For a complete detailed flowchart, reference can be made to FIG. 7. First, a user may watch various live streaming on a frontend application of an information pushing system through a user terminal, and set information about video accounts followed by the user. In addition, to improve convenience of order placing, the user may further set palmprint information for palmprint recognition and preset gesture information for gesture authentication on the frontend, and may further set logistics information, so as to directly generate order information after placing an order. When a user performs service settlement in a shop supporting palm authentication, information may be pushed to the user through the solution of this disclosure, thereby improving effectiveness of information pushing. First, when needing to perform service settlement, the user may input a palm image through a 3D camera of a frontend device of the shop. The frontend device acquires palm streaming media data of the user; recognizes palm information and image quality information of each frame of image in the palm streaming media data; and performs image screening on the palm streaming media data based on the palm information and the image quality information, to obtain the palm image of the user acquired by the frontend device. Then, a system backend performing information pushing performs palmprint recognition based on the palm image, to obtain identity information of the user. For example, a gesture image in acquired gesture information may be first obtained; noise removal and information enhancement are performed on the gesture image, to obtain a preprocessed image; a hand region in the preprocessed image is determined through gesture-based positioning; a segmentation contour corresponding to the hand region is determined through color-based positioning; and image segmentation is performed on the preprocessed image based on the segmentation contour, to obtain a hand region image. An image feature of the hand region image is extracted; the image feature of the hand region image is compared with an image feature of the preset gesture information, to obtain a gesture feature comparison result; and a result of gesture authentication on the acquired gesture information is determined based on the gesture feature comparison result. After the gesture authentication is completed and the identity information is obtained, a browsing history and a playback history that correspond to the identity information may be searched for; a feature of the user is extracted through a feature extraction model, and a user set feature corresponding to each user set is obtained; a similarity distance parameter between the feature of the user and a feature of each user set is determined; a similarity between the user and each user set is determined based on the similarity distance parameter; a similar user set of the user is determined based on the similarity; preference content of a similar user set is searched for; and live streaming push information corresponding to the identity information is determined based on the preference content. An identity signature to be used in the service processing process is generated based on the identity information of the user; the identity signature is fed back to the frontend device; and the push information is fed back to the frontend device, to perform service processing by using the identity signature and play the push information of the live streaming video content in the service processing process. The user may make a corresponding gesture in the 3D camera of the frontend device based on the push information, and then the frontend device feeds back acquired gesture information to the backend system based on acquired information. The backend system searches for the preset gesture information corresponding to the identity information, and performs gesture authentication on the acquired gesture information by using the preset gesture information; searches for service information corresponding to the push information when the gesture authentication succeeds; searches, based on the identity information, for receiver address information and receiver information that are preconfigured by the user; and fills in an order table corresponding to the service information based on the receiver address information and the receiver information, to generate order information corresponding to the push information.

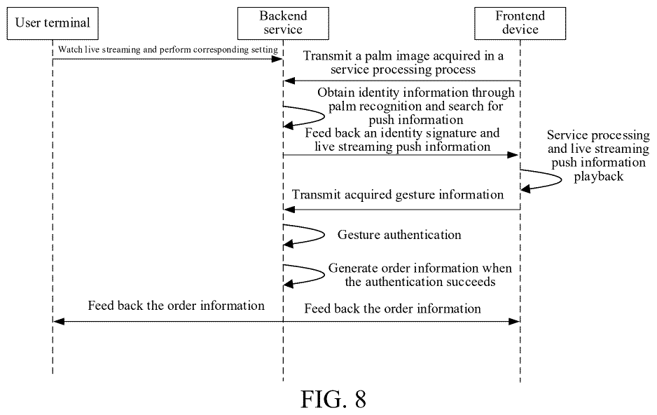

In another application scenario, for a timing diagram corresponding to implementation of the information pushing process in this disclosure, reference can be made to FIG. 8. First, through the user terminal, the user watches live streaming, sets live streaming preferences, and the like, and further sets an identity authentication process and sets logistics information. Then, the user arrives at a shop and performs corresponding service processing. The service processing process involves identity authentication. In this case, the user may directly perform identity authentication on a frontend device through hand scanning. Then, the frontend device feeds back a corresponding palm image to a backend system. The backend system performs palmprint recognition based on the palm image, to obtain identity information of the user, searches for corresponding push information based on the identity information of the user, and then feeds back an identity signature and the push information to the frontend device. During the background service processing by the frontend device through the identity signature, the frontend device may further play the push information on a display apparatus. The user may input preset gesture information on the frontend device based on the push information, and the backend system searches for the preset gesture information corresponding to the identity information, performs gesture authentication on acquired gesture information by using the preset gesture information; and generates order information corresponding to the push information when the gesture authentication succeeds, and pushes the order information to the user terminal and the frontend device.

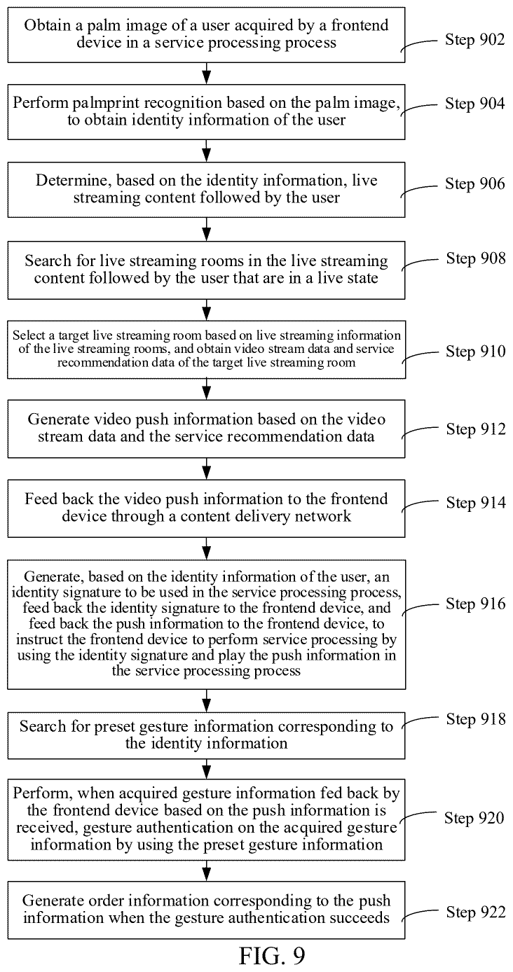

In an aspect, for an example of a process of the information pushing method in this disclosure, reference can be made to FIG. 9. The method includes the following operations:
Operation 902: Obtain a palm image of a user acquired by a frontend device in a service processing process. For example, a palm image of a user acquired by a frontend device during a service process is obtained.
Operation 904: Perform palmprint recognition based on the palm image, to obtain identity information of the user. For example, palmprint recognition is performed on the palm image to obtain identity information of the user.
Operation 906: Determine, based on the identity information, live streaming content followed by the user. For example, based on the identity information, live streaming content followed by the user is determined.
Operation 908: Search for live streaming rooms in the live streaming content followed by the user that are in a live state. For example, currently broadcasting live streaming channels in the live streaming content are searched.
Operation 910: Select a target live streaming room based on live streaming information of the live streaming rooms, and obtain video stream data and service recommendation data of the target live streaming room. For example, the target live streaming channel is selected based on live streaming information of the live streaming channels.
Operation 912: Generate video push information based on the video stream data and the service recommendation data. For example, video push information is generated based on the video stream data and the service recommendation data.
Operation 914: Feed back the video push information to the frontend device through a content delivery network. For example, on the frontend device, the video push information is output for display through a content delivery network.
Operation 916: Generate, based on the identity information of the user, an identity signature to be used in the service processing process, feed back the identity signature to the frontend device, and feed back the push to the frontend device, to instruct the frontend device to perform service processing by using the identity signature and play the push information in the service processing process. For example, based on the identity information of the user, an identity signature for use in the service process is generated. The identity signature is fed back to the frontend device. On the frontend device, the push information is output for display during the service process.
Operation 918: Search for preset gesture information corresponding to the identity information. For example, preset gesture information corresponding to the identity information of the user is searched.
Operation 920: Perform, when acquired gesture information fed back by the frontend device based on the push information is received, gesture authentication on the acquired gesture information by using the preset gesture information. For example, gesture authentication is performed on acquired gesture information received from the frontend device based on the push information, using the preset gesture information.
Operation 922: Generate order information corresponding to the push information when the gesture authentication succeeds. For example, order information corresponding to the push information is generated when the gesture authentication succeeds.

Although all of the operations in the flowcharts involved in the foregoing aspects are displayed in the order indicated by the arrows, these operations are unnecessarily executed in the order indicated by the arrows. Unless otherwise explicitly stated herein, an execution order of these operations is not strictly limited, and these operations may be executed in other orders. Moreover, at least some operations in the flowcharts involved in the foregoing aspects may include a plurality of operations or a plurality of stages. These operations or stages are unnecessarily executed at the same moment and may be executed at different moments. These operations or stages are unnecessarily sequentially executed, and may be executed sequentially or alternately with other operations or at least some operations or stages of other operations.

Based on the same inventive concept, an aspect of this disclosure further provides an information pushing apparatus configured to implement the foregoing information pushing method. Implementation solutions provided by the apparatus are similar to the implementation solutions described in the foregoing method. Therefore, for example definitions in one or more aspects of the information pushing apparatus provided below, reference can be made to the definitions in the information pushing method in the foregoing descriptions. Details are not described herein.

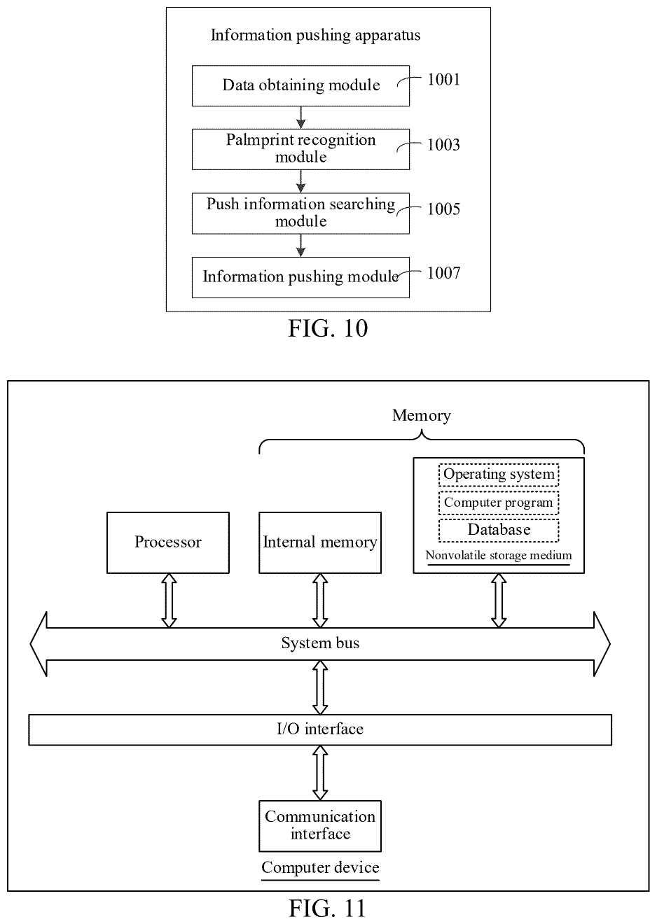

In an aspect, as shown in FIG. 10, an information pushing apparatus is provided, including:
a data obtaining module 1001, configured to obtain a palm image of a user acquired by a frontend device in a service processing process;
a palmprint recognition module 1003, configured to perform palmprint recognition based on the palm image, to obtain identity information of the user;
a push information searching module 1005, configured to search for push information matching the identity information of the user; and
an information pushing module 1007, configured to: generate, based on the identity information of the user, an identity signature to be used in the service processing process, feed back the identity signature to the frontend device, and feed back the push information to the frontend device, to instruct the frontend device to perform service processing by using the identity signature and play the push information in the service processing process.

In an aspect, the apparatus further includes an order generation module configured to: search for preset gesture information corresponding to the identity information; perform, when acquired gesture information fed back by the frontend device based on the push information is received, gesture authentication on the acquired gesture information by using the preset gesture information; and generate order information corresponding to the push information when the gesture authentication succeeds.

In an aspect, the order generation module is further configured to: search for service information corresponding to the push information when the gesture authentication succeeds; search, based on the identity information, for receiver address information and receiver information that are preconfigured by the user; and fill in an order table corresponding to the service information based on the receiver address information and the receiver information, to generate the order information corresponding to the push information.

In an aspect, the order generation module is further configured to: obtain a gesture image in the acquired gesture information; extract a hand region image from the gesture image; extract an image feature of the hand region image; compare the image feature of the hand region image with an image feature of the preset gesture information, to obtain a gesture feature comparison result; and determine a result of the gesture authentication on the acquired gesture information based on the gesture feature comparison result.

In an aspect, the order generation module is further configured to: perform noise removal and information enhancement on the gesture image, to obtain a preprocessed image; determine a hand region in the preprocessed image through gesture-based positioning; determine a segmentation contour corresponding to the hand region through color-based positioning; and perform image segmentation on the preprocessed image based on the segmentation contour, to obtain the hand region image.

In an aspect, the data obtaining module 1001 is configured to: acquire palm streaming media data of the user through the frontend device in the service processing process; recognize palm information and image quality information of each frame of image in the palm streaming media data; and perform image screening on the palm streaming media data based on the palm information and the image quality information, to obtain the palm image of the user acquired by the frontend device.

In an aspect, the push information searching module 1005 is configured to: search for a browsing history and a playback history that correspond to the identity information; and perform preference prediction based on the browsing history and the playback history, to obtain the push information matching the identity information of the user.

In an aspect, the push information searching module 1005 is further configured to: determine a similarity between the user and each user set based on the browsing history and the playback history; determine a similar user set of the user based on the similarity; search for preference content of the similar user set; and obtain, based on the preference content, the push information matching the identity information of the user.

In an aspect, the push information searching module 1005 is further configured to: extract a feature of the user through a feature extraction model, and obtain a user set feature corresponding to each user set; determine a similarity distance parameter between the feature of the user and each user set feature; and determine a similarity between the user and each user set based on the similarity distance parameter.

In an aspect, the push information includes live streaming push information. The push information searching module 1005 is further configured to: determine, based on the identity information, live streaming content followed by the user; search for live streaming rooms in the live streaming content followed by the user that are in a live state; and select a target live streaming room based on live streaming information of the live streaming rooms, and use the live streaming information of the target live streaming room as the push information matching the identity information of the user.

In an aspect, the push information searching module 1005 is further configured to: select the target live streaming room based on the live streaming information of the live streaming rooms, and obtain video stream data and service recommendation data of the target live streaming room; generate video push information based on the video stream data and the service recommendation data; and feed back the video push information to the frontend device through a content delivery network.

In an aspect, the push information searching module 1005 is further configured to: select the target live streaming room based on the live streaming information of the live streaming rooms, and obtain the live streaming information of the target live streaming room; search for to-be-pushed services corresponding to the frontend device; determine a target service in the to-be-pushed services that is associated with the live streaming information; and use the target service and the live streaming information as the push information matching the identity information of the user.

In an aspect, the system further includes a push continuation module configured to: generate a push continuation message corresponding to the push information when a service completion message fed back by the frontend device is received, and push the push continuation message to the user terminal of the user.

The modules in the foregoing information pushing apparatus may be implemented in whole or in part by software, hardware, and a combination thereof. All of the modules may be embedded in or independent of a processor in a computer device in a form of hardware, or may be stored in a memory in the computer device in a form of software, so that the processor may invoke and execute operations corresponding to the modules.

In an aspect, a computer device is provided. The computer device may be a server. An internal structure thereof may be shown in FIG. 11. The computer device includes a processor (an example of processing circuitry), a memory (an example of a non-transitory computer-readable storage medium), an input/output interface (I/O for short), and a communication interface. The processor, the memory, and the I/O interface are connected through a system bus, and the communication interface is connected to the system bus through the I/O interface. The processor of the computer device is configured to provide computing and control capabilities. The memory of the computer device includes a nonvolatile storage medium and an internal memory. The nonvolatile storage medium has an operating system, a computer program, and a database stored therein. The internal memory provides an environment for running of the operating system and the computer program in the nonvolatile storage medium. The database of the computer device is configured to store data related to information pushing. The I/O interface of the computer device is configured for information exchange between the processor and an external device. The communication interface of the computer device is configured to connect to and communicate with an external terminal through a network. The computer program, when executed by the processor, implements an information pushing method.

It is noted that the structure shown in FIG. 11 is merely an example block diagram of a part of the structure related to the solution of this disclosure, and does not constitute a limitation on the computer device to which the solution of this disclosure is applied. Specific computer devices may include more or less components than those shown in the figure, some merged components, or different component arrangements.

An aspect further provides a computer device, including a memory and a processor. The memory has a computer program stored therein. The processor, when executing the computer program, implements the operations of the foregoing method aspects.

An aspect provides a computer-readable storage medium, such as a non-transitory computer-readable storage medium, having a computer program stored therein. The computer program, when executed by a processor, implements the operations of the foregoing method aspects.

An aspect of this disclosure provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, so that the computer device performs the operations of the foregoing method aspects.

A person of ordinary skill in the art may understand that all or some of the processes of the method in the foregoing aspects may be implemented by a computer program instructing relevant hardware. The computer program may be stored in a nonvolatile computer-readable storage medium. When the computer program is executed, the processes of the foregoing method aspects may be implemented. Any reference to a memory, a database, or other media used in the aspects provided in this disclosure may include at least one of a nonvolatile memory or a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache, or the like. As a description rather than a limitation, the RAM may have various forms, such as a static random access memory (SRAM) or a dynamic random access memory (DRAM). The database involved in the aspects provided in this disclosure may include at least one of a relational database or a non-relational database. The non-relational database may include a blockchain-based distributed database, and is not limited thereto. The processor involved in the aspects provided in this disclosure may be a general purpose processor, a central processing unit, a graphics processing unit, a digital signal processor, a programmable logic unit, or a data processing logic unit based on quantum computing, and is not limited thereto.

The technical features of the foregoing aspects may be combined in different manners. To make description concise, not all possible combinations of the technical features in the foregoing aspects are described. However, the combinations of these technical features shall be considered as falling within the scope recorded by this specification provided that no conflict exists.

The foregoing aspects merely describe some implementations of this disclosure, which are described as examples and in detail, but cannot be construed as a limitation on the scope of the disclosure. For a person of ordinary skill in the art, transformations and improvements may be made without departing from the idea of this disclosure. These transformations and improvements belong to the scope of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. An information pushing method, comprising:
obtaining, by processing circuitry, a palm image of a user acquired by a frontend device during a service process;
performing palmprint recognition on the palm image to obtain identity information of the user;
searching for push information that matches the identity information of the user;
generating, based on the identity information of the user, an identity signature for use in the service process;
feeding back the identity signature to the frontend device; and
outputting for display, on the frontend device, the push information during the service process.

2. The method according to claim 1, wherein the push information includes media content determined based on the identity information of the user, the media content being determined based on a user history.

3. The method according to claim 1, further comprising:
searching for preset gesture information corresponding to the identity information of the user;
performing gesture authentication on acquired gesture information received from the frontend device based on the push information, using the preset gesture information; and
generating order information corresponding to the push information when the gesture authentication succeeds.

4. The method according to claim 3, wherein the generating the order information corresponding to the push information comprises:
searching for service information corresponding to the push information;
searching, based on the identity information of the user, for delivery address information and recipient information preconfigured by the user; and
populating an order form corresponding to the service information based on the delivery address information and the recipient information, to generate the order information corresponding to the push information.

5. The method according to claim 3, wherein the performing the gesture authentication comprises:
obtaining a gesture image included in the acquired gesture information;
extracting a hand region image from the gesture image;
extracting an image feature of the hand region image;
comparing the image feature of the hand region image with an image feature of the preset gesture information to obtain a gesture feature comparison result; and
determining a result of the gesture authentication based on the gesture feature comparison result.

6. The method according to claim 5, wherein the extracting the hand region image from the gesture image comprises:
performing noise removal and information enhancement on the gesture image to obtain a preprocessed image;
determining a hand region in the preprocessed image through gesture-based positioning;
determining a segmentation contour of the hand region through color-based positioning; and
performing image segmentation on the preprocessed image based on the segmentation contour to obtain the hand region image.

7. The method according to claim 1, wherein the obtaining the palm image of the user comprises:
acquiring a palm video stream of the user through the frontend device during the service process;
determining palm information and image quality information of each frame of in the palm video stream; and
performing image screening on the palm video stream based on the palm information and the image quality information to obtain the palm image of the user.

8. The method according to claim 1, wherein the searching for the push information matching the identity information of the user comprises:
searching for a user history corresponding to the identity information; and
performing preference prediction based on the user history to obtain the push information matching the identity information of the user.

9. The method according to claim 8, wherein the performing the preference prediction based on the user history comprises:
determining a similarity between the user and each user set based on the user history;
determining a similar user set of the user based on the similarity;
searching for preference content of the similar user set; and
obtaining the push information matching the identity information of the user based on the preference content.

10. The method according to claim 9, wherein the determining the similarity between the user and each user set comprises:
extracting a feature of the user through a feature extraction model;
obtaining a user set feature for each user set;
determining a similarity distance parameter between the feature of the user and the user set feature of each user set; and
determining the similarity between the user and each user set based on the similarity distance parameter.

11. The method according to claim 1, wherein the push information includes a target live streaming channel, and the searching for the push information matching the identity information of the user comprises:
determining, based on the identity information, live streaming content followed by the user;
searching for currently broadcasting live streaming channels in the live streaming content; and
selecting the target live streaming channel based on live streaming information of the live streaming channels.

12. The method according to claim 11, wherein the feeding back the push information to the frontend device comprises:
selecting the target live streaming channel based on the live streaming information of the live streaming channels;
obtaining video stream data and service recommendation data of the target live streaming channel;
generating video push information based on the video stream data and the service recommendation data; and
outputting for display on the frontend device, the video push information through a content delivery network.

13. An information processing apparatus, comprising:
processing circuitry configured to:
obtain a palm image of a user acquired by a frontend device during a service process;
perform palmprint recognition on the palm image to obtain identity information of the user;
search for push information that matches the identity information of the user;
generate, based on the identity information of the user, an identity signature for use in the service process;
feed back the identity signature to the frontend device; and
output for display, on the frontend device, the push information during the service process.

14. The apparatus according to claim 13, wherein the push information includes media content determined based on the identity information of the user, the media content being determined based on a user history.

15. The apparatus according to claim 13, wherein the processing circuitry is configured to:
search for preset gesture information corresponding to the identity information of the user;
perform gesture authentication on acquired gesture information received from the frontend device based on the push information, using the preset gesture information; and
generate order information corresponding to the push information when the gesture authentication succeeds.

16. The apparatus according to claim 15, wherein the processing circuitry is configured to:
search for service information corresponding to the push information;
search, based on the identity information of the user, for delivery address information and recipient information preconfigured by the user; and
populate an order form corresponding to the service information based on the delivery address information and the recipient information, to generate the order information corresponding to the push information.

17. The apparatus according to claim 15, wherein the processing circuitry is configured to:
obtain a gesture image included in the acquired gesture information;
extract a hand region image from the gesture image;
extract an image feature of the hand region image;
compare the image feature of the hand region image with an image feature of the preset gesture information to obtain a gesture feature comparison result; and
determine a result of the gesture authentication based on the gesture feature comparison result.

18. The apparatus according to claim 17, wherein the processing circuitry is configured to:
perform noise removal and information enhancement on the gesture image to obtain a preprocessed image;
determine a hand region in the preprocessed image through gesture-based positioning;
determine a segmentation contour of the hand region through color-based positioning; and
perform image segmentation on the preprocessed image based on the segmentation contour to obtain the hand region image.

19. The apparatus according to claim 13, wherein the processing circuitry is configured to:
acquire a palm video stream of the user through the frontend device during the service process;
determine palm information and image quality information of each frame of in the palm video stream; and
perform image screening on the palm video stream based on the palm information and the image quality information to obtain the palm image of the user.

20. A non-transitory computer-readable storage medium storing instructions which, when executed by a processor, cause the processor to perform:
obtaining a palm image of a user acquired by a frontend device during a service process;
performing palmprint recognition on the palm image to obtain identity information of the user;
searching for push information that matches the identity information of the user;
generating, based on the identity information of the user, an identity signature for use in the service process;
feeding back the identity signature to the frontend device; and
outputting for display, on the frontend device, the push information during the service process.
